(19) United States
(12) Patent Application Publication
(10) Pub. No.: US 2014/0107326 A1
(43) Pub. Date: Apr. 17, 2014

(54) METHODS INVOLVING GRAPHENE AND FUNCTIONALIZED GRAPHENE

(71) Applicant: Massachusetts Institute of Technology, (US)

(72) Inventors: Timothy M. Swager, Newton, MA (US); Yu Lin Zhong, Singapore (SG)

(73) Assignee: Massachusetts Institute of Technology, Cambridge, MA (US)

(21) Appl. No.: 13/788,819

(22) Filed: Mar. 7, 2013

Related U.S. Application Data
(60) Provisional application No. 61/715,055, filed on Oct. 17, 2012.

(51) Int. Cl. C01B 31/04

(52) U.S. Cl. CPC C01B 31/0484
USPC 534/558; 205/555

(57) ABSTRACT

Embodiments relating to the synthesis and processing of graphene molecules are provided. In some cases, methods for the electrochemical expansion and/or functionalization of graphene molecules are provided. In some embodiments, one or more species may be intercalated between adjacent graphene sheets.

### RELATED APPLICATIONS

This application claims priority under 35 U.S.C. §119(e) to co-pending U.S. Provisional Application Ser. No. 61/715,055, filed Oct. 17, 2012, the contents of which are incorporated herein by reference in its entirety for all purposes.

Statement Regarding Federally Sponsored Research or Development This invention was made with government support under Grant No. W911NF-07-D-0004 awarded by the Army Research Office. The government has certain rights in this invention.

### FIELD OF THE INVENTION

Embodiments relating to graphene molecules and functionalized graphene molecules are provided, including related devices and methods.

### BACKGROUND OF THE INVENTION

Graphene exhibits exceptional electronic properties first observed on the Scotch tape exfoliated graphene by Novoselov and co-workers. To realize the technological potential of graphene, new versatile processes to create low defect graphene from abundant and inexpensive carbon sources have been pursued based on a variety of potential target applications. For example, graphene produced by chemical vapor deposition (CVD) or by epitaxial growth are utilized in electronic applications despite the higher cost associated with these production methods. For applications seeking to exploit other outstanding properties of graphene (e.g. optical, mechanical, barrier, and surface area), lower cost bulk chemical production of graphene from graphite via the graphene oxide route has received much attention. However, a limitation of this route is the generation of defective graphene basal planes (vacancy defects) resulting from the exceptionally harsh oxidizing conditions that cannot be completely repaired effectively even after thermal or chemical reduction.

Alternative non-oxidative routes to the chemical production of graphene include the use of solvent/surfactant-assisted liquid exfoliation of graphite, the formation of graphite intercalated compounds (GICs), and electrochemical methods. There are drawbacks and limitations with each method, but a primary limiting factor has been the relatively low yields of single-layer graphene (SLG), and the inability of current methods to compete with the strong π-π intersheet interactions that favor stacked graphite sheets and deintercalation processes. Furthermore, the use of reactive intercalators such as sodium and potassium metals generally precludes the attachment of many functional groups in the subsequent chemical functionalization step. The high yield synthesis of few-layer graphene (FLG) flakes through electrochemical expansion of graphite was recently developed by Loh and co-workers but an additional prolonged power sonication step was required and the associated mechanical breakdown limited the size of graphene flakes.

### SUMMARY OF THE INVENTION

Various compositions, methods, and devices relating to graphene molecules and functionalized graphene molecules are provided.

In some embodiments, methods are provided comprising exposing first and second adjacent graphene sheets to a first species under a set of conditions which facilitates electrochemical intercalation of the first species between the first and second graphene sheets, producing an activated graphene material; and exposing the activated graphene material to a second species under a set of conditions which facilitates electrochemical intercalation of second species between the first and second adjacent graphene sheets of the activated graphene material, wherein the first species, intercalated between the first and second adjacent graphene sheets, facilitates intercalation of the second species between the first and second adjacent graphene sheets.

In some embodiments, methods for synthesizing functionalized graphene sheets are provided comprising exposing first and second adjacent graphene sheets to a cationic species having a diameter of at least 3 Å under a set of conditions which facilitates electrochemical intercalation of the cationic species between the first and second adjacent graphene sheets, producing an activated graphene species; and reacting the activated graphene species with a functional group precursor to form a functionalized graphene molecule.

In some embodiments, methods are provided comprising exposing first and second adjacent graphene sheets to a cationic species under a set of conditions which facilitates electrochemical intercalation of the cationic species between the first and second adjacent graphene sheets, producing an activated graphene material, wherein, under said set of conditions, the cationic species, intercalated between the first and second adjacent graphene sheets, undergoes an electrochemical transformation to produce a neutral species.

### BRIEF DESCRIPTION OF THE DRAWINGS

FIG. 1. shows (a) a schematic representation of the electrochemical expansion of graphite and (b) both a schematic representation and photographs of the electrochemical expansion of graphite, according to one embodiment.

FIG. 2 shows (a) XPS survey scans and (b) Cls XPS spectrum of electrochemically expanded graphene (i) after rinsing once with DMF and (ii) after extensive washing.

FIG. 3 shows photographs of (a) the supernatant of (i) chemically functionalized graphene, (ii) electrochemically functionalized graphene and (iii) control in DMF after centrifugation; (b) a flexible free standing electrochemically functionalized graphene film peeled off from polycarbonate filter membrane; (c) a SEM micrograph of electrochemically functionalized graphene film edge; and (d) a vial containing concentrated (0.1 mg/ml) electrochemically functionalized graphene dispersion in DMF after weeks of standing displaying Tyndall effect.

FIG. 4 shows (a) XPS survey scans and (b) TGA spectrum of (i) chemically functionalized graphene with reaction time of 4 h and electrochemically functionalized graphene with reaction time of (ii) 1 h and (iii) 4 h.

FIG. 5 shows optical micrographs of electrochemically functionalized graphenes spin-coated on silicon (a) before and (b) after laser ablation, as well as Raman spectra of selected spots (i)-(iii) both (c) before and (d) after laser ablation.

FIG. 6 shows a calibration plot of voltages applied with respect to the platinum mesh electrode and its corresponding voltages with respect to a standard calomel electrode (SCE), which was immersed into the electrolyte via a liquid junction bridge to prevent contamination from the SCE. (Inset: Reaction scheme for electrochemical decomposition of TBA cation and its decomposition potential of −2.5 V (vs SCE)1 is highlighted.)

FIG. 7 shows an X-ray diffraction (XRD) pattern of (i) chemically functionalized graphene (CFG) film with reaction time of 4 h and electrochemically functionalized graphene (EFG) film with reaction time of (ii) 1 h and (iii) 4 h.

FIG. 8 shows optical micrographs of the spin-coated EFG on silicon substrate with (a) 10× and (b) 50× magnification/FIG. 9 shows an optical micrographs of spin-coated EFG on silicon substrate and Raman spectra of spots (1) to (9) before (left column) and after (right column) laser ablation.

FIG. 10 shows the mechanism for the electrochemical decomposition of propylene carbonate, as described in Xu et al, Chem. Rev. 2004, 104, 4303-4417.

Other aspects, embodiments and features of the invention will become apparent from the following detailed description when considered in conjunction with the accompanying drawings. The accompanying figures are schematic and are not intended to be drawn to scale. For purposes of clarity, not every component is labeled in every figure, nor is every component of each embodiment of the invention shown where illustration is not necessary to allow those of ordinary skill in the art to understand the invention. All patent applications and patents incorporated herein by reference are incorporated by reference in their entirety. In case of conflict, the present specification, including definitions, will control.

### DETAILED DESCRIPTION

Embodiments described herein generally relate to synthesis and processing of graphene molecules. In some cases, methods for the expansion and/or functionalization of graphene molecules are provided.

Methods describes herein may advantageously be performed without need for the harsh oxidation and/or reduction of graphene in order to attach functional groups, which can introduce many hole defects on the graphene sheets, reducing its conductivity and thus performance. Additionally, methods for synthesizing functionalized graphene molecules may be simplified, scalable (e.g., using industrial electrolysis technology), and cost-effective, without need for long reaction times, harsh power sonication, surfactants, reactive graphite intercalation compounds, and/or non-ideal electrochemical methods. Using the embodiments described herein, graphene molecules including a wide variety of functional groups may be synthesized in high yield. Such molecules may be utilized alone or within nanocomposites (e.g., with nanoparticles or polymers) in applications ranging from transparent conducting displays and supercapacitors to biosensors and electrocatalysts, as well others.

In some cases, methods for intercalating one or more species between two adjacent graphene sheets are provided. For example, a first graphene sheets and second, adjacent graphene sheet may be exposed to a first species under a set of conditions which facilitates intercalation (e.g., electrochemical intercalation) of the first species between the first and second graphene sheets, producing an activated graphene material. The first and second adjacent graphene sheets can refer to graphene sheets which are positioned to be substantially continuously in sufficient proximity such that they interact via pi-pi stacking interactions, rather than, for example, graphene sheets which are randomly dissolved or dispersed in a fluid carrier and which do not interact with one another substantially continuously via pi-pi stacking interactions. In some cases, the first and second adjacent graphene sheets may be arranged within a bulk graphite material, including graphite powder, graphite flakes, orientated pyrolytic graphite, graphite sheets, and the like. In some embodiments, the first and second adjacent graphene sheets are arranged as adjacent graphene layers within graphite.

In some cases, intercalation of a species (e.g., a cationic species) between the first and second adjacent graphene sheets may be carried out under electrochemical conditions. For example, intercalation may be performed by applying a voltage to a mixture containing a fluid carrier (e.g., propylene carbonate), a material containing the first and second adjacent graphene sheets, and the species. In some cases, the voltage may be negative. In some cases, a voltage of in the range of about −2.5 to about −6.0 may be applied. In some cases, a voltage of in the range of about −3.0 to about −5.0 may be applied. In some cases, a single voltage may be applied to the material and species for a period of time. In some cases, a range of voltages may be applied to the material and species over a period of time.

Typically, the species to be intercalated between the first and second adjacent graphene sheets may be a cationic species, including inorganic cations and organic cations, as described more fully herein. In some cases, one type of cationic species may be intercalated between the first and second adjacent graphene sheets. In some cases, more than one type of cationic species may be intercalated simultaneously between the first and second adjacent graphene sheets. In some cases, more than one type of cationic species may be sequentially intercalated between the first and second adjacent graphene sheets. For example, a first species may be intercalated between the first and second adjacent graphene sheets, followed by intercalation of a second, different species between the first and second adjacent graphene sheets. In some embodiments, the first species, when intercalated between the first and second adjacent graphene sheets, may facilitate intercalation of the second species between the first and second adjacent graphene sheets. In some cases, the second species may not be intercalated between the first and second adjacent graphene sheets in the absence of the first species.

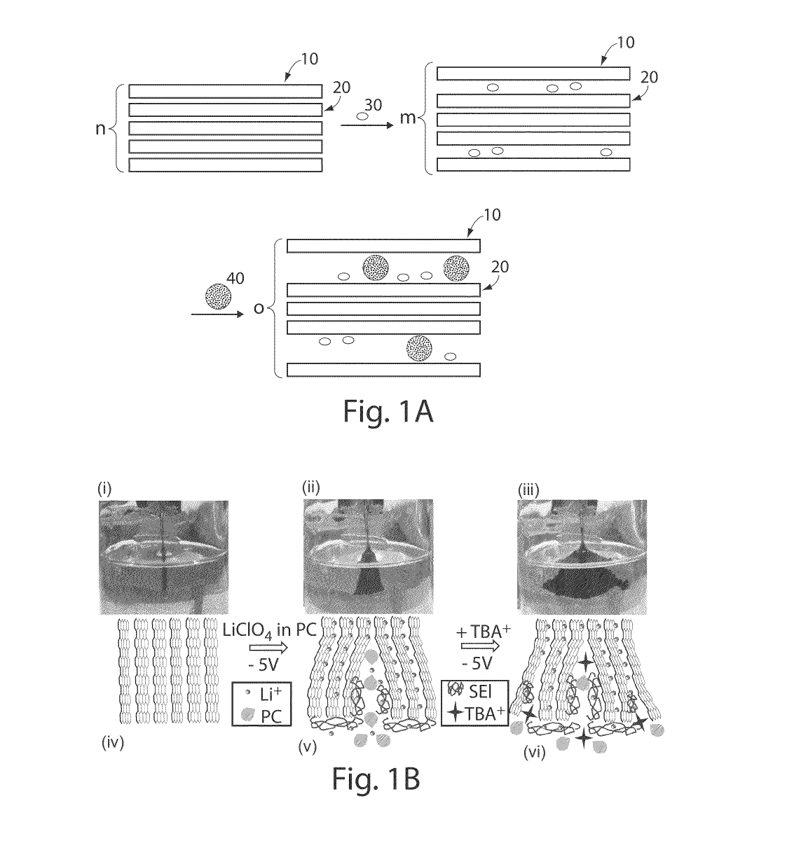

For example, the first species may be a cationic species having relatively small diameter, such as a lithium ion, and a second species may be a cationic species having a relatively large diameter (e.g., at least 3 Å), such as a tetraalkylammonium cation. Intercalation of the first species between graphene sheets of a graphite material may activate the graphite material, facilitating the intercalation of the second species. However, in the absence of the first species intercalated within the graphite material, the second species may not be successfully intercalated within the graphite material. FIG. 1A shows an illustrative embodiment where graphene molecule within a graphite material can be expanded via sequential intercalation of various species. A first graphene molecule 10 and a second graphene molecule 20 may be arranged as adjacent layers within a graphite material containing a stack of graphene molecules with a height n. Species 30 may be intercalated between graphene molecules 10 and 20 upon application of a voltage, resulting in expansion of the graphite material such that the stack of graphene molecules has a height, m, where m is greater than n. The graphite material may be further expanded by treatment with a second species 40 that may have a greater diameter than species 30. Intercalation of species 40 between graphene molecules 10 and 20 may result in a further expanded graphite material such that the stack of graphene molecules has a height, o, where o is greater than m.

In some cases, the distance between the first and second adjacent graphene sheets (e.g., within graphite) in the absence of the intercalated species is increased by about 1%, about 5%, about 10%, about 25%, about 50%, about 75%, about 100%, about 250%, about 500%, about 750%, about 1000%, about 1250%, about 1500%, about 1750%, about 2000%, about 3000%, about 5000%, about 7000%, about 10,000%, or greater, upon electrochemical intercalation of one or more types of species described herein.

In some cases, the average thickness of a graphite material in the absence of intercalated species is increased by about 1%, about 5%, about 10%, about 25%, about 50%, about 75%, about 100%, about 250%, about 500%, about 750%, about 1000%, about 1250%, about 1500%, about 1750%, about 2000%, about 3000%, about 5000%, about 7000%, about 10,000%, or greater, upon electrochemical intercalation of one or more types of species described herein within the graphite material.

In some embodiments, intercalation of various species may occur between single graphene molecules. In some embodiments, intercalation of various species may occur between multi-layer graphene molecules. Multi-layer graphene molecules may include about 2 to about 100, about 2 to about 75, about 2 to about 50, about 2 to about 25, or about 2 to about 10 graphene sheets.

Methods described herein may also provide additional features which facilitate the intercalation of species between graphene sheets and, hence, enhance the expansion of materials such as graphite. In some cases, the method may involve one or more chemical or electrochemical processes (e.g., electrodecomposition, electro-polymerization) which provide a driving force for the continuous intercalation of species between graphene sheets. In some cases, the method may involve a chemical or electrochemical process that results in the formation of separation layers between graphene sheets.

For example, some embodiments may involve electrochemical intercalation of a cationic species between adjacent graphene sheets and concomitant neutralization of the cationic species upon intercalation. In some cases, electro-decomposition of the intercalated cationic species may at least partially neutralize positive charges within a graphite lattice, thereby continually maintaining a driving force for intercalation of additional cationic species within the graphite lattice. The neutralized species may, in some cases, be deposited on the surface of the graphene sheet. In some cases, an organic cationic species such as a tetraalkylammoniun cation may be intercalated within a graphite lattice and may decompose to a neutral species. As a result, additional organic cationic species may be intercalated within the graphite lattice. The organic cationic species may be any species capable of undergoing electro-decomposition or electro-polymerization under substantially the same (e.g., identical) conditions as the electrochemical intercalation of the organic cationic species. Examples of such organic cationic species include, for example, alkyl-substituted ammonium cations and pyridinium cations.

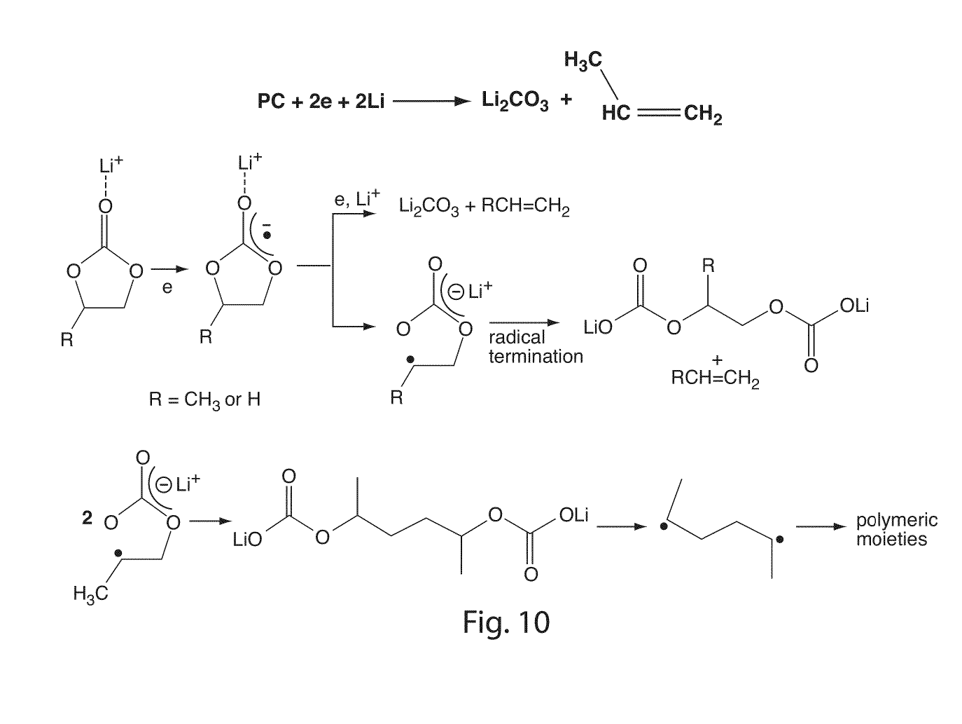

In some cases, the method may involve a process that produces separation layers between graphene sheets. For example, the electrochemical expansion of adjacent graphene sheets may be performed in the presence of one or more components capable of undergoing a chemical or electrochemical transformation to form separation layers on the surface of the graphene sheets under the same set of conditions as the electrochemical intercalation of species described herein. Such layers can serve as physical spacers between adjacent graphene sheets and can facilitate further expansion and/or functionalization of the graphene sheets. In some cases, the component may be a solvent, such as an organic solvent. The solvent may, for example, undergo electrodecomposition to form a solid-electrolyte interface (SEI) layer on the surface of the first graphene sheet and/or second graphene sheet. Such layers can advantageously acts as physical spacers between adjacent sheets of graphene, further enhancing the intercalation/expansion process. The solvent may be selected to be compatible (e.g., soluble with) with the graphene or graphite material and the various species to be intercalated within the graphene or graphite material, and to be capable of undergoing a chemical or electrochemical transformation under similar or identical conditions as the intercalation of species described herein to form a solid-electrolyte interface layer. In some cases, the solvent may be an apolar protic solvent, such as N,N-dimethylformamide (DMF), 1,2-dimethoxyethane (DME), dimethylsulfoxide (DMSO), or propylene carbonate. In one set of embodiments, the solvent is propylene carbonate. FIG. 10 shows the electrodecomposition of propylene carbonate to form a polymeric material that may be formed on the surface of a graphene sheet as a solid-electrolyte interface layer.

FIG. 1B shows an illustrative embodiment, where electrochemical expansion (e.g., via intercalation of charged species between graphene sheets) of graphite is performed. In the first step, graphite may be expanded and charged with lithium ions by applying a negative voltage to the graphite in a propylene carbonate solution containing lithium perchlorate. This charging and expansion step may be attributed to the intercalation of positive lithium ions into the graphite lattice upon negatively bias and concomitant decomposition of intercalated propylene carbonate to propylene gas which helps expansion and disruption of stacked graphite sheet. However, this step alone produces only a low level of expansion and intercalation, with the graphite still containing a high percentage of unexpanded graphite. Without wishing to be bound by theory, this may be attributed to a lack of further driving force for expansion once the graphite is fully charged with lithium ions.

In the second step shown in FIG. 1B, the addition of tetrabutylammonium (TBA) cations in form of TBA salts (e.g. TBAPF₆, TBAClO₄) enhances the electrochemical expansion process. With the addition of TBA and application of sufficiently high negative voltage (e.g., >−4.5V vs. Pt), the intercalation and electrodecomposition of TBA may occur between the graphite lattice causing further graphite expansion. Due to the continuous decomposition and neutralization of intercalated TBA cations, a constant driving force to attract new TBA cations into the graphite lattice is provided. Simultaneously, propylene carbonate accompanying the solvated TBA cations can partake in the electrochemical decomposition in the graphite lattice, forming solid-electrolyte-interface (SEI) film consisting mainly of lithium alkyl carbonates. (FIG. 10) The SEI film may act as a physical spacer causing expansion in the graphite lattice.

Some embodiments provide methods for synthesizing functionalized graphene molecules. For example, the method may involve first treating a graphite material to form an activated graphene species (e.g., via expansion/intercalation methods described herein), and then reacting the activated graphene species with a functional group precursor to form functionalized graphene molecules. In some embodiments, the activated graphene species may be reacted with the functional group precursor chemically. In some embodiments, the activated graphene species may be reacted with the functional group precursor electrochemically, where the degree of functionalization may be controlled by varying, for example, the applied voltage or reaction time. In some cases, the functionalized graphene molecule may be a single-layer functionalized graphene molecule. In some cases, the functionalized graphene molecule may be a multi-layer functionalized graphene molecule.

Activating a graphite material using the expansion/intercalation methods described herein may, in some cases, allow for enhanced functionalization of the graphene molecule. Using previous methods, functionalization of graphene molecules may have been difficult due to the lack of sufficient, available reaction sites on the graphene molecules (e.g., defects or rippled sites for attachment). However, using methods described herein, the sufficiently expanded structure of the graphite material, in some cases into single-layer graphene sheets, and/or the presence of electrochemically generated separation layers (e.g., SEI layers) within the graphite material may allow for a wide range of functional group precursors to more readily intercalate within and/or react with the graphene molecules. For example, SEI layers within a graphite lattice can help to create ripple sites on multi-layer graphene flakes which can act as reactive sites for covalent attachment of functional groups.

The functional group precursor may be any species capable of forming a bond with a graphene molecule, including graphene molecules within an activated graphite material (e.g., a graphite material comprising intercalated species and/or separation layers as described herein). For example, the functional group precursor may be selected to contain an electrophile, such as a carbonyl group. In some cases, the functional group precursor contains a diazonium group (e.g., an aryldiazonium group), a transition metal having a formal charge of +1 or greater, a main group atom substituted with an electronegative group, an aryl group optionally substituted with one or more halogens (e.g., benzyl halide), or an alkyl group optionally substituted with one or more halogens. The main group atom may be, for example, B, Al, Sn, Si, Ga, P, Sn, As, Sb, or Pb.

In some cases, the functional group precursor may be selected to include a polymerizable group. The polymerizable group may be any functional group capable of undergoing polymerization, for example, exposure to high temperature, electromagnetic radiation, a particular chemical reagent, or other polymerization conditions. The polymerizable group may be polymerized according to known methods, including, but not limited to, cationic polymerization, anionic polymerization, radical polymerization, condensation polymerization, Wittig polymerization, ring-opening polymerization, cross-coupling polymerization, addition polymerization, chain polymerization, or the like. Those of ordinary skill in the art would be able to select the appropriate polymerizable group and/or polymerization reaction conditions suitable for use in a particular application. For example, the polymerizable group may include, for example, an olefinic group, acrylate group, or other group capable of forming radicals upon exposure to, for example, electromagnetic radiation. In one set of embodiments, the functional group precursor comprises styrene sulfonic acid.

In one set of embodiments, the functional group precursor comprises an aryldiazonium group (e.g., an aryldiazonium salt). A graphite material may be treated, as described herein, to form an expanded, activated graphene species including intercalated species and/or separation layers between graphene sheets. Subsequently, the activated graphene species may be covalently functionalized via the electrochemical reduction and attachment of an aryldiazonium salt.

In an illustrative embodiment, the method may involve the electrochemical expansion of graphite in an electrolyte containing a propylene carbonate and lithium salts, followed by another electrochemical expansion of graphite in an electrolyte containing a propylene carbonate and tetrabutylammonium cations. Subsequently, the electrochemically expanded graphite can be subjected to in situ functionalization (e.g., electrochemical functionalization, chemical functionalization) with a functional group precursor such as an aryldiazonium salt. This expansion-functionalization method may effectively yield functionalized graphene molecules, including single-layer and multi-layer graphene molecules.

As used herein, exposure to a “set of conditions” may comprise, for example, exposure to a particular temperature, pH, solvent, chemical reagent, type of atmosphere (e.g., nitrogen, argon, oxygen, etc.), source of external energy (e.g., voltage), or the like. In some cases, the set of conditions may be selected to facilitate intercalation of a species within two adjacent sheets of graphene or other processing of graphene or graphite. In some cases, the set of conditions may be selected to facilitate chemical transformation of a species, for example, from a charged species to a neutral species. In some cases, the set of conditions may be selected to facilitate transformation of an organic solvent via electrodecomposition. Some embodiments may a set of conditions comprising exposure to a source of external energy. The source of energy may comprise electromagnetic radiation, electrical energy, sound energy, thermal energy, or chemical energy. For example, the set of conditions comprises application of a voltage. In some embodiment, the set of conditions comprises exposure to a particular potential, solvent, chemical species, and/or functional group precursor.

As described herein, a cationic species may be intercalated between two adjacent graphene sheets. In some cases, the cationic species is an inorganic cationic species. The inorganic cationic species may include, in some cases, a Group 1A or Group 2A metal ion. As used herein, a Group 1A metal ion refers to ions of lithium, sodium, potassium, rubidium, cesium, and francium. As used herein, a Group 2A metal ion refers to ions of beryllium, magnesium, calcium, strontium, barium, and radium. In some embodiments, the cationic species comprises Li⁺, Na⁺, K⁺, Rb⁺, Ca²⁺, or Ba²⁺.

In some cases, the cationic species is an organic cationic species. For example, the cationic species may include an ammonium cation. The ammonium cation may be substituted with optionally substituted alkyl groups, optionally substituted aryl groups, combinations thereof, and the like. In some embodiments, the cationic species is an ammonium cation substituted with optionally substituted alkyl groups, such as C₁₋₈ alkyl groups (e.g., methyl, ethyl, propyl, isopropyl, butyl, sec-butyl, tert-butyl, pentyl, hexy, heptyl, or octyl). In some embodiments, the cationic species is an ammonium cation substituted with optionally substituted aryl groups.

In some cases, the cationic species may have a diameter of at least 3 Å. In some cases, the cationic species may have a diameter of at least 5 Å. In some cases, the cationic species may have a diameter of at least 10 Å.

The term “alkyl” refers to the radical of saturated aliphatic groups, including straight-chain alkyl groups, branched-chain alkyl groups, cycloalkyl (alicyclic) groups, alkyl substituted cycloalkyl groups, and cycloalkyl substituted alkyl groups. The alkyl groups may be optionally substituted, as described more fully below. Examples of alkyl groups include, but are not limited to, methyl, ethyl, propyl, isopropyl, butyl, isobutyl, tert-butyl, 2-ethylhexyl, cyclopropyl, cyclobutyl, cyclopentyl, cyclohexyl, and the like.

The term “aryl” refers to an aromatic carbocyclic group having a single ring (e.g., phenyl), multiple rings (e.g., biphenyl), or multiple fused rings in which at least one is aromatic (e.g., 1,2,3,4-tetrahydronaphthyl, naphthyl, anthryl, or phenanthryl), all optionally substituted. “Heteroaryl” groups are aryl groups wherein at least one ring atom in the aromatic ring is a heteroatom, with the remainder of the ring atoms being carbon atoms. Examples of heteroaryl groups include furanyl, thienyl, pyridyl, pyrrolyl, N lower alkyl pyrrolyl, pyridyl N oxide, pyrimidyl, pyrazinyl, imidazolyl, indolyl and the like, all optionally substituted.

The terms “acyl,” “carboxyl group,” or “carbonyl group” are recognized in the art and can include such moieties as can be represented by the general formula:

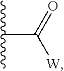

wherein W is H, OH, O-alkyl, O-alkenyl, or a salt thereof. Where W is O-alkyl, the formula represents an “ester.” Where W is OH, the formula represents a “carboxylic acid.” In general, where the oxygen atom of the above formula is replaced by sulfur, the formula represents a “thiolcarbonyl” group. Where W is a S-alkyl, the formula represents a “thiolester.” Where W is SH, the formula represents a “thiolcarboxylic acid.” On the other hand, where W is alkyl, the above formula represents a “ketone” group. Where W is hydrogen, the above formula represents an “aldehyde” group.

The term “substituted” is contemplated to include all permissible substituents of organic compounds, “permissible” being in the context of the chemical rules of valence known to those of ordinary skill in the art. In some cases, “substituted” may generally refer to replacement of a hydrogen with a substituent as described herein. However, “substituted,” as used herein, does not encompass replacement and/or alteration of a key functional group by which a molecule is identified, e.g., such that the “substituted” functional group becomes, through substitution, a different functional group. For example, a “substituted phenyl” must still comprise the phenyl moiety and cannot be modified by substitution, in this definition, to become, e.g., a heteroaryl group such as pyridine. In a broad aspect, the permissible substituents include acyclic and cyclic, branched and unbranched, carbocyclic and heterocyclic, aromatic and nonaromatic substituents of organic compounds. Illustrative substituents include, for example, those described herein. The permissible substituents can be one or more and the same or different for appropriate organic compounds. For purposes of this invention, the heteroatoms such as nitrogen may have hydrogen substituents and/or any permissible substituents of organic compounds described herein which satisfy the valencies of the heteroatoms. This invention is not intended to be limited in any manner by the permissible substituents of organic compounds.

Examples of substituents include, but are not limited to, alkyl, aryl, aralkyl, cyclic alkyl, heterocycloalkyl, hydroxy, alkoxy, aryloxy, perhaloalkoxy, aralkoxy, heteroaryl, heteroaryloxy, heteroarylalkyl, heteroaralkoxy, azido, amino, halogen, alkylthio, oxo, acylalkyl, carboxy esters, carboxyl, carboxamido, nitro, acyloxy, aminoalkyl, alkylaminoaryl, alkylaryl, alkylaminoalkyl, alkoxyaryl, arylamino, aralkylamino, alkylsulfonyl, carboxamidoalkylaryl, carboxamidoaryl, hydroxyalkyl, haloalkyl, alkylaminoalkylcarboxy, aminocarboxamidoalkyl, alkoxyalkyl, perhaloalkyl, arylalkyloxyalkyl, and the like.

Having thus described several aspects of some embodiments of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

### EXAMPLES AND EMBODIMENTS

Chemicals and Materials: Graphite foil of 1/32″ thickness (John Crane's Crane-foil™) was purchased from McMaster-Carr, USA, and is an economical source of graphite electrodes. Lithium perchlorate (battery grade, dry, 99.99% trace metals basis), propylene carbonate (anhydrous, 99.7%), tetrabutylammonium perchlorate (for electrochemical analysis, ≧99.0%) and 4-bromobenzenediazonium tetrafluoroborate (96%) were purchased from Sigma-Aldrich and used as received. All solvents used were of HPLC grade unless otherwise stated. Millipore water (18.2 MΩ·cm) was used for sample rinsing and preparation of all aqueous solutions.

X-ray Photoelectron Spectroscopy (XPS): XPS was performed with an X-ray photoelectron spectrometer (Versaprobe II, Physical Electronics) operated in constant analyzer energy mode with a monochromated Al α X-ray source (1486.6 eV). The photoemission angle was 45° with respect to the sample normal, and a base pressure of 10⁻⁹ Ton was maintained throughout the XPS analysis. Curve-ftting of the core XPS lines was carried out using CasaXPS software with a Gaussian-Lorentzian product function and a Shirley background subtraction.

Scanning Electron Microscopy (SEM): SEM images were obtained in a field-emission scanning electron microscope (6700F, JEOL) operating with an accelerating voltage of 10 keV.

Thermal Gravimetric Analysis (TGA): TGA was carried out with a thermal gravimetric analyzer (TGA Q50, TA Instruments) in air with a temperature ramp of 5° C./min.

X-ray Diffraction (XRD): X-ray diffraction patterns of the graphene films were recorded on a Bruker Advance D8 diffractometer using Nickel-filtered Cu—Kα radiation (λ=1.5418 Å) with accelerating voltage and current of 40 kV and 40 mA, respectively. Four Point Probe. Sheet resistance of the graphene film was measured with four point probe station (SCS 4200, Keithley) by supplying a current through the outer two probes and measuring the voltage across the inner two probes.

Raman Spectroscopy: Raman Spectroscopy was performed with a micro-Raman system (LabRAM HR800, Horiba Jobin Yvon) with a 532 nm excitation laser (laser spot size of 2 μm) operated at a low power level (˜1 mW) in order to avoid damaging the organic functional groups. The graphene dispersion of 0.1 mg/ml in DMF was spin-coated onto silicon substrate (with 300 nm oxide) at 1500 rpm for 90 second and dried in vacuum oven before measurements. For laser ablation, the neutral density filter was removed to allow full laser power (532 nm) to reach the targeted spot and Raman spectra were taken periodically until there was no further change. Thereafter, the Raman spectrum of the laser-ablated spot was taken with lower power laser (532 nm).

### Example 1

The following example describes a process for electrochemical expansion of graphene sheets from graphite. This two-step process involved first activating graphite in Li⁺ containing electrolytes and then further activating/expanding the graphite by additional activation in tetra-n-butylammonium (TBA) electrolytes.

A thin strip of graphite foil (2 mm×17 mm) was peeled several times via Scotch tape to reduce the its thickness to about <0.5 mm The reduction in thickness was performed to control the size of the fully expanded graphite foil. The graphite foil was connected to the negative terminal of a DC power supply (Model D-612T, EPSCO Incorporated, USA) via a flat head alligator clip and a platinum mesh was employed at the positive terminal. The voltage applied across the two terminals was accurately monitored (±0.1 V) by a general purpose multimeter. Only 10 mm of the graphite foil was immersed into 0.1 M lithium perchlorate (LiClO₄) in 60 ml propylene carbonate (PC). The electrochemical setup was prepared in a home-made desiccator incorporating an electrical feed-through and argon purging to minimize water ingress. A slow voltage ram was applied to achieve a final potential −5.0 V (as too fast of a voltage ramp could result in the graphite foil undesirably flaking into pieces). A typical voltage ramp was as follows: −3.0 V to −5.0 V at a voltage step of −0.25 V per 5 min. After pre-conditioning the graphite foil in the LiClO₄/PC solution at −5.0 V for 15 min, the voltage supply was cut off and the graphite foil was removed from the electrolyte. At this time, 0.615 g (1.80 mmoles) of tetra-n-butylammonium perchlorate (TBAP) was dissolved into the existing electrolyte and the pre-conditioned graphite was then re-immersed into the electrolyte. A potential of −5.0 V was the applied for approximately 24 hours in order to achieve full expansion of graphite foil.

As described above, the activation of graphite began with the immersion of a thin strip of graphite foil in propylene carbonate containing lithium perchlorate and a voltage ramp to −5 V (vs Pt mesh). In this pre-conditioning step, the graphite foil observably expanded along its c axis due to the co-intercalation of propylene carbonate with lithium ions and the well-known concomitant electrodecomposition to form a solid-electrolyte-interphase (SEI) layer with evolution of propylene gas. (FIG. 1A) The graphite foil ceased to expand beyond the application of −5 V as the graphite lattice became fully charged with lithium ions. Notably, the application of more negative voltages likely resulted in the electrolysis of lithium perchlorate and the electrodeposition of lithium metal on the graphite as evidenced by the formation of a greyish coating.

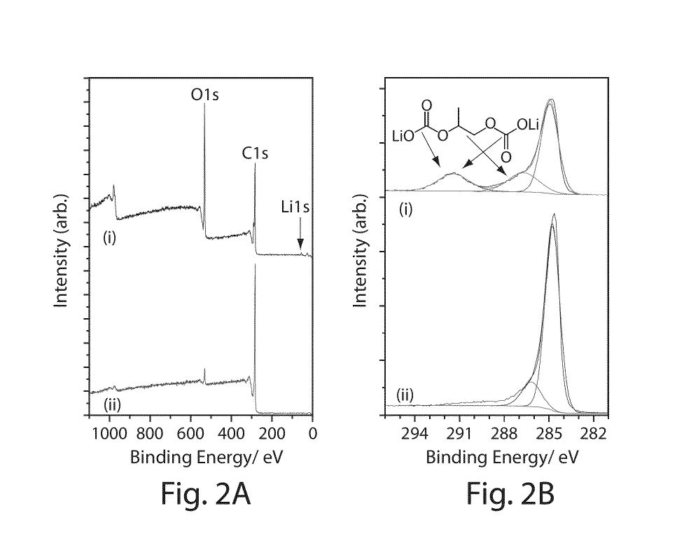

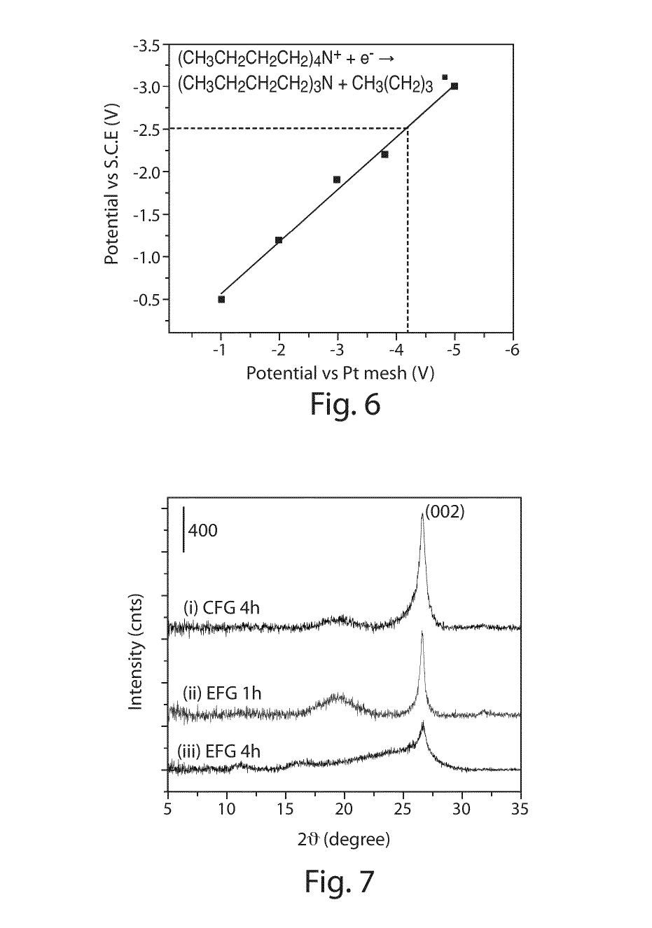

In the second step, tetra-n-butylammonium perchlorate was added into the electrolyte solution and applied potential is maintained at −5 V for 24 hours, and a physical increase in the size of the expanded graphite is observed. (FIG. 1B) During this enhanced electrochemical expansion step, it appeared that positively charged TBA cations penetrated into the graphite lattice by cation exchange with the intercalated lithium ions. However, an additional factor was the electrodecomposition of the intercalated TBAs which partially neutralized the positive charges within the graphite lattice and thereby continually maintained a driving force for intercalation of TBA cations. FIG. 6 shows a calibration plot of voltages applied with respect to the platinum mesh electrode and its corresponding voltages with respect to a standard calomel electrode (SCE), which was immersed into the electrolyte via a liquid junction bridge to prevent contamination from the SCE. (Inset: Reaction scheme for electrochemical decomposition of TBA cation and its decomposition potential of −2.5 V (vs SCE)1 is highlighted.) This process was inferred from the lack of graphite expansion when the applied voltage was less than the electrodecomposition potential of TBA (−2.5 V vs standard calomel electrode). Similarly, there was also a concomitant electrodecomposition of propylene carbonate molecules (solvating the TBA cations) resulting in a constant generation of SEI layers, which are known to act as physical spacers within the graphite lattice. (FIG. 1B) The identity of the SEI layer was confirmed by X-ray photoelectron spectroscopy (XPS) to consist of lithium alkyl carbonates. The SEI layer could be removed by extensive washing as evidenced by the significantly reduced XPS Ols peak. (FIG. 2A) The small shoulder in the XPS Cls at around 286.2 eV indicated that there may be a small degree of covalently linked alcohol or ether functional groups or residual solvent molecules trapped between the graphene sheets. (FIG. 2B(ii))

### Example 2

The following example describes the functionalization of graphene sheets. This enhanced expansion of the graphite allows for functionalization of individual graphene sheets and we demonstrate in situ electrochemical functionalization of the expanded graphite foil with the post-addition of aryldiazonium salts.

After the full electrochemical expansion of graphite foil, the electrochemically expanded graphene (EEG) was subjected to the in situ electrochemical functionalization with aryldiazonium salts to obtain the electrochemically functionalized graphene (EFG). Reactions with 4-bromobenzenediazonium tetrafluoroborate were selected because the bromide provides a chemical marker for XPS analysis and this reagent demonstrated the compatibility of this method towards a reductively sensitive functional group. For comparison, chemical functionalization of the EEG was carried out by first dispersing the EEG in dimethylacetamide (DMAc) followed by addition of the aryldiazonium salt to obtain the chemically functionalized graphene (CFG). The resulting products were then washed and extracted, as described below.

In situ electrochemical functionalization: After subjecting graphite to an electrochemical expansion step as described in Example 1, the electrochemically expanded graphite (EEG) was discharged until its residual voltage was below −0.5 V before withdrawing it from the electrolyte. 0.812 g (3 mmoles) 4-bromobenzenediazonium tetrafluoroborate (4-BrBD) was dissolved into the existing electrolyte and the EEG was re-immersed back into the electrolyte. A potential of −1.0 V was then applied to the EEG for 1 to 4 hours to obtain the electrochemically functionalized graphene (EFG) and an extensive washing step (see below) was carried out thereafter.

Chemical functionalization: After subjecting graphite to an electrochemical expansion step as described in Example 1, the EEG was discharged until its residual voltage was below −0.5 V before withdrawing it out of the electrolyte. The expanded portion of the film was separated by cutting with a razor blade and dropped into 100 mL dimethylacetamide (DMAc). The EEG was dispersed by mild sonication for less than 15 min before adding 0.812 g (3 mmoles) 4-BrBD and stirred for 1 to 4 hours. Chemically functionalized graphene (CFG) was recovered via centrifugation and the extensive washing step (see below) was carried out thereafter.

Washing Step: After the respective functionalization steps, the graphene product was consecutively dispersed in 200 mL of the following solvents: acetone, 50% ethanol, dichloromethane and dimethylformamide (DMF) via mild sonication (Bransonic 1510, Branson) for 15 min and filtered through a polypropylene filter membrane (0.6 μm pore size, Millipore). The washing step for each solvent was carried out at least twice.

Extraction Step: After the extensive washing step, the graphene filter cake was dispersed in 200 ml DMF via mild sonication (<15 min) and centrifuged at 1000 rpm for 30 min (Model 5810R, Eppendorf). The supernatant was carefully decanted without disturbing the residue and typically yielded a dispersion of about 170 mL in volume.

As a control experiment, electrochemical functionalization on the EEG without the addition of TBA salts was performed. Graphite that had only been subjected to the −5.0 V pre-conditioned graphite foil in 0.1 M LiClO₄ in PC without TBAP for 24 hours was used. After this electrolysis, it was subjected to the same in situ electrochemical functionalization, extensive washing steps, and extraction steps.

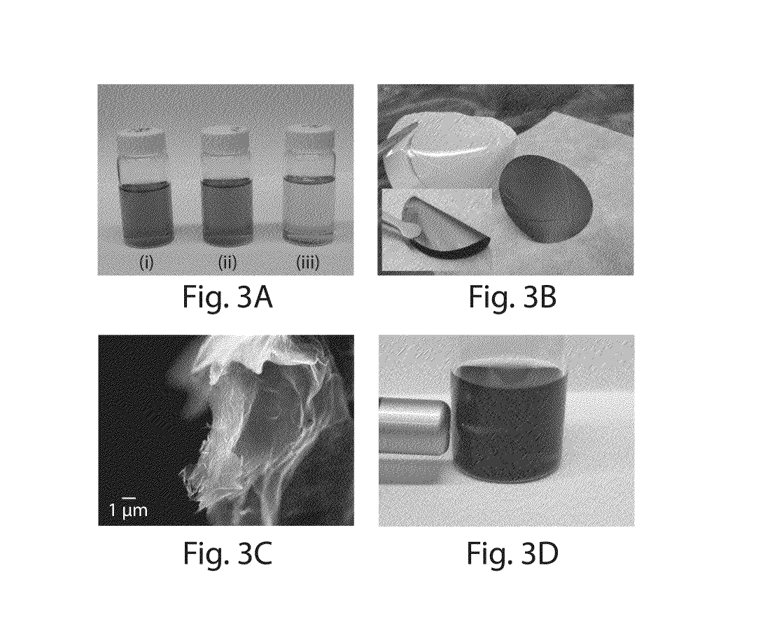

FIG. 3 shows photographs of (a) the supernatant of (i) chemically functionalized graphene, (ii) electrochemically functionalized graphene and (iii) control in DMF after centrifugation; (b) a flexible free standing electrochemically functionalized graphene film peeled off from polycarbonate filter membrane; (c) a SEM micrograph of electrochemically functionalized graphene film edge; and (d) a vial containing concentrated (0.1 mg/ml) electrochemically functionalized graphene dispersion in MF after weeks of standing displaying Tyndall effect. As shown in FIG. 3A, the supernatants of the CFG and EFG were homogeneously dark with concentrations over 20 μg/ml as compared to the clear supernatant from the control procedure. (Table 1) These results suggested that the addition of the TBA salts results in the hyperexpansion of graphite such that individual graphene sheets are functionalized.

TABLE 1
Weight of immersed graphite foil (GF) electrodes and functionalized graphene
(G) film products, their supernatant concentrations, reaction yields and summary of
their chemical and physical properties.

| | Wt. of | Wt. of G | | | | | Film |
|---|---|---|---|---|---|---|---|
| | immersed GF | film | Concentration | TGA wt. | Yield | XPS Br | resistance |
| Samples | (mg) | (mg) | (μg/ml) | % at 500° C. | (%) | atomic % | (Ω/□) |
| EFG | 8.6 | 3.8 | 22 | 70 | 31 | 5.2 | 8300 |
| (4 h) | | | | | | | |
| EFG | 9.3 | 4.6 | 27 | 80 | 40 | 2.8 | 8200 |
| (1 h) | | | | | | | |
| CFG | 10.4 | 4.4 | 26 | 80 | 34 | 2 | 270 |
| (4 h) | | | | | | | |

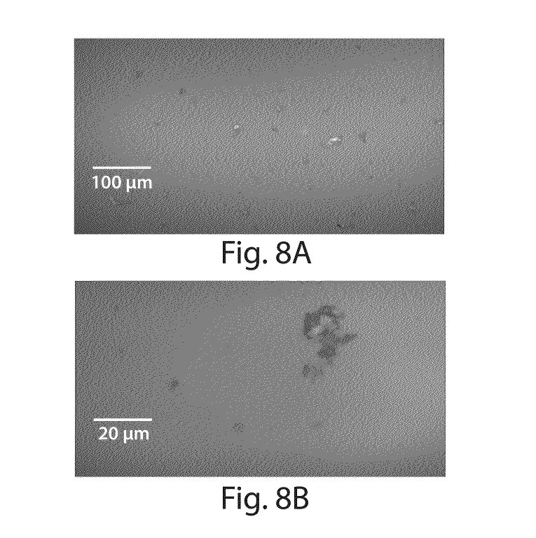

Flexible free-standing EFG films could be obtained by filtration of the EFG dispersion. (FIG. 3B) The supernatant of the graphene dispersions in DMF were filtered through polypropylene membrane filter and washed with ethanol. The filter cake were then dispersed in 200 ml of ethanol via mild sonication (<15 min) and separated by filtration through a hydrophilic polycarbonate (0.6 μm pore size, Millipore). After drying in vacuum oven at 60° C. for a few hours, the hydrophobic graphene film can be easily peeled off from the hydrophilic polycarbonate membrane filter. These films containing randomly stacked EFG sheets as evidenced from SEM analysis of the film edges (FIG. 3C) and a very weak (002) reflection characteristic of the graphite layers in the X-ray diffraction (XRD) pattern. (FIG. 7) Concentrated EFG solutions of 0.1 mg/ml can be readily prepared by dispersing the EFG film in DMF with no significant sedimentation observed after standing for three weeks. (FIG. 3D)

### Example 3

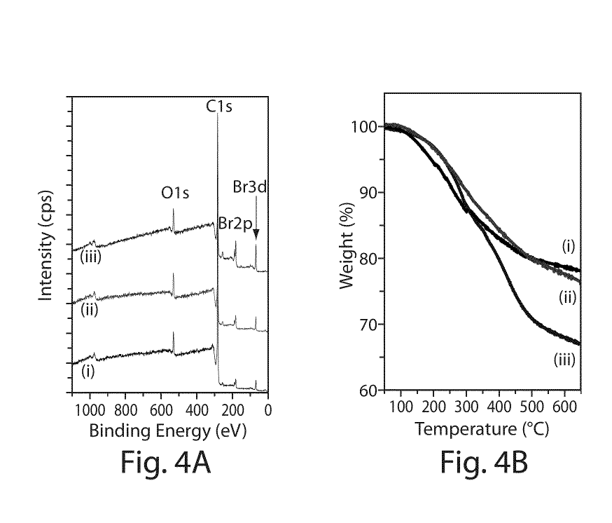

FIG. 4 shows (a) XPS survey scans and (b) TGA spectrum of (i) chemically functionalized graphene with reaction time of 4 h and electrochemically functionalized graphene with reaction time of (ii) 1 h and (iii) 4 h. FIG. 7 shows an X-ray diffraction (XRD) pattern of (i) chemically functionalized graphene (CFG) film with reaction time of 4 h and electrochemically functionalized graphene (EFG) film with reaction time of (ii) 1 h and (iii) 4 h.

XPS analysis of the functionalized graphene films demonstrated a controllable degree of functionalization as a function of the bromine signal at varying electrochemical functionalization times. In contrast the bromine content did not increase with longer functionalization times for CFGs. (FIG. 4A) Thermal gravimetric analysis (TGA) weight loss measured at 500° C. provided a representative measure of the weight percentage of functional groups in each of the functionalized samples. (FIG. 4B) A distinct difference between the EFG and CFG films was that the CFG film displayed a sheet resistance an order in magnitude lower than that of the EFG film. (Table 1) This implied a lower degree of basal plane functionalization on the CFG and a higher degree of direct contact between re-stacked graphene sheets, which is consistent with the stronger XRD (002) reflection as compared to the EFG films. (FIG. 7)

Based on product weight of the functionalized graphene films and their respective graphene contents from TGA, the calculated yields of functionalized graphene were in the range of 30 to 40%. (Table 1) These values are a lower estimate and only a single extraction of the total solids with DMF has been performed and sonication was kept to a minimum to avoid defects. There are many factors such as the counter electrode, electrolyte concentration, electrolysis voltage and reaction time that could be further optimized in future studies to provide improved yields. Nevertheless, the present procedure is compatible with industrial electrolyzers for ease of scale up.

### Example 4

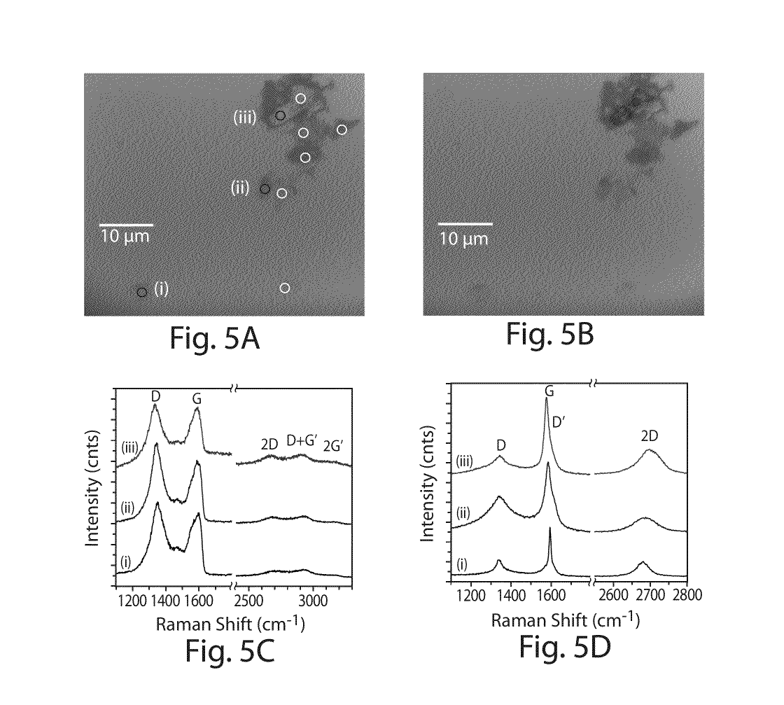

EFG dispersions (0.1 mg/mL in DMF) were spin-coated on silicon wafers (300 nm oxide layer) for characterization with optical microscopy and Raman spectroscopy. FIG. 5 shows optical micrographs of electrochemically functionalized graphenes spin-coated on silicon (a) before and (b) after laser ablation, as well as Raman spectra of selected spots (i)-(iii) both (c) before and (d) after laser ablation.

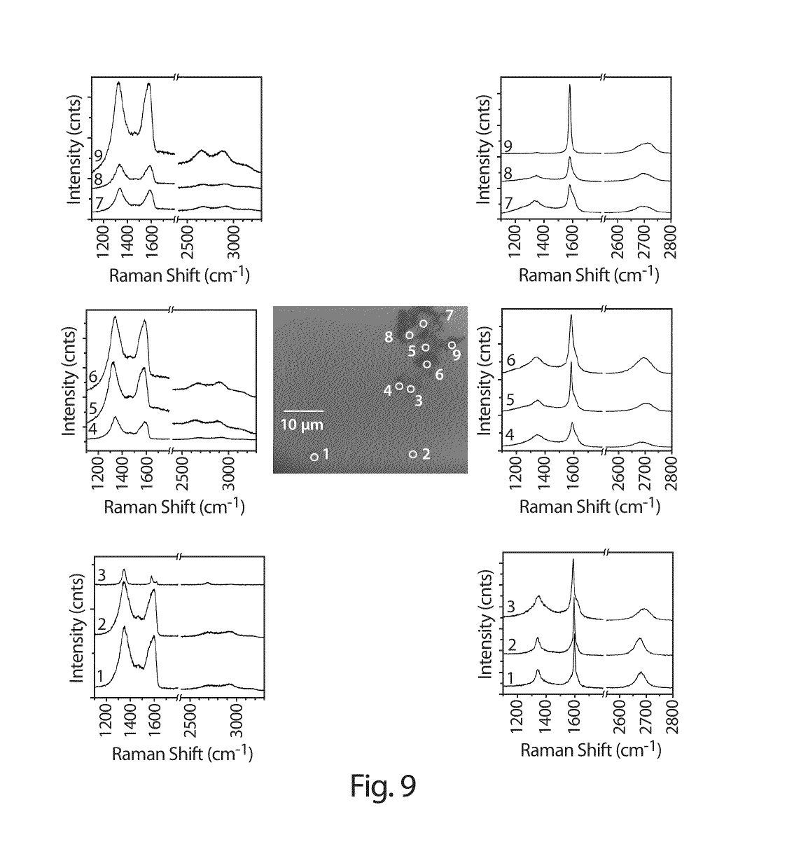

FIG. 8 shows optical micrographs of the spin-coated EFG on silicon substrate with (a) 10× and (b) 50× magnification. FIG. 9 shows an optical micrographs of spin-coated EFG on silicon substrate and Raman spectra of spots (1) to (9) before (left column) and after (right column) laser ablation.

Optical micrographs of the spin-coated EFG showed coverage of the substrate with micron-sized graphene flakes with predominantly light blue color over a large area (10x magnification) and also flakes that appear as light grey areas at higher magnifications. (FIG. 8) Raman spectra of these EFG flakes (FIG. 5C and FIG. 9) shown in FIG. 5A were obtained with a laser spot size of 2 μm. The I_{D}/I_{G} ratios of all the EFG flakes were consistently found to be higher than 1.1 indicating that a high degree of covalent functionalization was achieved for all observed graphene flakes. High power laser ablation (>100 mW) was subsequently performed on previously analyzed spots and distinguishable laser “bum marks” were noted on the light blue color EFG flakes. (FIG. 5B) The post-laser ablation Raman analysis of all the spots revealed significantly reduced D peaks confirming the removal of covalently attached organic functional groups and restoration to near pristine graphene sheets. (FIG. 5D and FIG. 9). By contrast, the D peak of graphene oxide (GO) was reported to remain high after laser ablation, as a result of the presence of irreparable structural edge defects and the smaller graphene domains. The narrowing of the G band after laser treatment to a single sharp peak is also indicative of a carbon state transition from an amorphous to a crystalline state. The emergence of a sharp symmetrical 2D peak at 2680 cm⁻¹ in some of the analyzed flakes was observed, which is typically indicative of single layer graphene. Based on the 2D spectral shape observed in the rest of the graphene flakes, it was concluded that all the graphene flakes in the EFG film product contained less than five layers of graphene sheets.

What is claimed:

1. A method, comprising:
exposing first and second adjacent graphene sheets to a first species under a set of conditions which facilitates electrochemical intercalation of the first species between the first and second graphene sheets, producing an activated graphene material; and
exposing the activated graphene material to a second species under a set of conditions which facilitates electrochemical intercalation of second species between the first and second adjacent graphene sheets of the activated graphene material,
wherein the first species, intercalated between the first and second adjacent graphene sheets, facilitates intercalation of the second species between the first and second adjacent graphene sheets.

2. A method as in claim 1, wherein the first and second adjacent graphene sheets are arranged as graphene layers within graphite, and the distance between the first and second adjacent graphene sheets within the graphite in the absence of the first and second species is increased upon intercalation of the second species.

3. A method as in claim 1, wherein the first species is a cationic species.

4. A method in as in claim 1, wherein the first species is an inorganic cationic species.

5. A method in as in claim 4, wherein the inorganic cationic species comprises a Group 1A or Group 2A metal ion.

6. A method as in as in claim 1 wherein the first species comprises Li⁺, Na⁺, K⁺, Rb⁺, Ca²⁺, Me⁺, or Ba²⁺.

7. A method as in as in claim 1, wherein the second species is a cationic species.

8. A method as in claim 1, wherein the second species has a diameter of at least 3 Å.

9. A method in as in claim 1, wherein the second species is an organic cationic species.

10. (canceled)

11. A method as in claim 1, wherein the second species is an ammonium cation optionally substituted with alkyl groups.

12. (canceled)

13. A method as in claim 1, further comprising the step of:
reacting, after exposure of the activated graphene material to the second species, the activated graphene species with a functional group precursor to form a functionalized graphene molecule.

14. A method as in claim 13, wherein the functionalized graphene molecule is a functionalized, single-layer graphene molecule or a functionalized, multi-layer graphene molecule.

15. A method as in claim 13, wherein the functional group precursor comprises an electrophile.

16. (canceled)

17. A method as in claim 13, wherein the functional group precursor comprises a diazonium group, a transition metal having a formal charge of +1 or greater, a main group atom substituted with an electronegative group, an aryl group optionally substituted with one or more halogens, or an alkyl group optionally substituted with one or more halogens.

18. A method as in claim 17, wherein the main group atom is B, Al, Sn, Si, Ga, P, Sn, As, Sb, or Pb.

19. A method as in claim 13, wherein the functional group precursor comprises a polymerizable group, producing a functionalized graphene molecule substituted with the polymerizable group.

20. A method as in claim 13, wherein the functional group precursor comprises a carbonyl, an aryldiazonium salt, a benzyl halide, or a styrene sulfonic acid.

21-29. (canceled)

30. A method as in claim 1, wherein the step(s) of exposing is performed in the presence of a solvent and, under said set of conditions, the solvent undergoes electrodecomposition to form a solid-electrolyte interface (SEI) layer on the surface of the first graphene sheet and/or second graphene sheet.

31. (canceled)

32. A method for synthesizing a functionalized graphene sheet, comprising:
exposing first and second adjacent graphene sheets to a cationic species having a diameter of at least 3 Å under a set of conditions which facilitates electrochemical intercalation of the cationic species between the first and second adjacent graphene sheets, producing an activated graphene species; and
reacting the activated graphene species with a functional group precursor to form a functionalized graphene molecule.

33-64. (canceled)

65. A method, comprising:
exposing first and second adjacent graphene sheets to a cationic species under a set of conditions which facilitates electrochemical intercalation of the cationic species between the first and second adjacent graphene sheets, producing an activated graphene material,
wherein, under said set of conditions, the cationic species, intercalated between the first and second adjacent graphene sheets, undergoes an electrochemical transformation to produce a neutral species.

66-97. (canceled)
